(19) United States
(12) Patent Application Publication
(10) Pub. No.: US 2013/0226777 A1
(43) Pub. Date: Aug. 29, 2013

(54) APPARATUS, METHOD, AND COMPUTER PROGRAM PRODUCT FOR CREDIT CARD PROFITABILITY SCORING

(71) Applicants: Po Hu, (US); Jean-Pierre Gerard, (US)

(72) Inventors: Po Hu, (US); Jean-Pierre Gerard, (US)

(73) Assignee: MasterCard International Incorporated, Purchase, NY (US)

(21) Appl. No.: 13/403,577

(22) Filed: Feb. 23, 2012

(51) Int. Cl. G06Q 40/02

(52) U.S. Cl. 705/38

(57) ABSTRACT

Data is obtained for a plurality of credit accounts for a first predetermined period of time. For each account in the plurality of credit accounts, an expected profitability is calculated based on the data. The expected profitability includes, for each given one of the accounts, an estimated probability of default for a given one of the accounts multiplied by, for each given one of the accounts: the minimum of zero and an increase in balance from scoring to default, in case of a default within a second predetermined period of time; and the maximum of zero and the increase in balance from scoring to default, multiplied by an annual percentage rate, in case of no default within the second predetermined period of time. At least one action is taken based on the expected profitability calculated for the plurality of credit accounts.

### FIELD OF THE INVENTION

The present invention relates generally to electronic commerce, and, more particularly, to electronic payment systems.

### BACKGROUND OF THE INVENTION

Credit cards provide a popular technique for payment. A credit card permits its holder to make purchases based on the holder's promise to pay for same. The card issuer creates a revolving account and grants a line of credit to the user from which he or she can borrow money for payment to a merchant or as a cash advance to the user.

Unlike a charge card, which requires the balance to be paid in full each month, credit cards allow the consumer a continuing balance of debt, subject to interest being charged. A credit card is also different than a cash card, which can be used like currency by the cardholder. Most credit cards are issued by banks or credit unions.

Credit card issuers seek to ensure that credit cards, with their associated lines of credit, are only issued to suitably credit-worthy individuals. In a traditional (credit) line management approach, the probability of default is measured. Average behavior is assumed for loss prediction. The financial impact is overlaid at the segment level based on the probability of default. Cut-off scores and line decisions are driven by policy simulations.

### SUMMARY OF THE INVENTION

Principles of the present invention provide techniques for credit card profitability scoring. An exemplary embodiment of a method (which can be computer-implemented), according to one aspect of the invention, includes the steps of obtaining data for a plurality of credit accounts for a first predetermined period of time; and, for each account in the plurality of credit accounts, calculating an expected profitability based on the data. The expected profitability includes, for each given one of the accounts, an estimated probability of default for a given one of the accounts multiplied by, for each given one of the accounts: the minimum of zero and an increase in balance from scoring to default, in case of a default within a second predetermined period of time; and the maximum of zero and the increase in balance from scoring to default, multiplied by an annual percentage rate, in case of no default within the second predetermined period of time. A further step includes taking at least one action based on the expected profitability calculated for the plurality of credit accounts.

In another aspect, an exemplary system includes a memory; at least one processor operatively coupled to the memory; and a persistent storage device operatively coupled to the memory and storing in a non-transitory manner instructions which when loaded into the memory cause the at least one processor to be operative to carry out or otherwise facilitate and one, some, or all of the method steps described herein.

Aspects of the invention contemplate the method(s) performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein.

One or more embodiments of the invention can provide substantial beneficial technical effects, including, for example:
Using information from multiple data sources to assess account level risk and make decisions based on the expected value of future returns
Use one unique equation at the account level to optimize the complete financial impact of risk
Generate scores to lead to more accurate detection of value at risk

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a general example of a payment system that can implement techniques of the invention;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers;

FIG. 3 depicts an exemplary risk scores value added assessment, according to an aspect of the invention;

FIG. 4 depicts an exemplary process overview, according to an aspect of the invention;

FIG. 5 shows how transaction data complements other available data sources, according to an aspect of the invention;

FIG. 6 depicts exemplary construction of customer level transaction input variables, according to an aspect of the invention;

FIG. 7 shows how target variable Y is discretized into buckets of profitability levels, according to an aspect of the invention;

FIG. 8 depicts an exemplary cut off decision table, according to an aspect of the invention;

FIG. 9 depicts an exemplary architecture diagram, according to an aspect of the invention; and

FIG. 10 is a block diagram of an exemplary computer system useful in one or more embodiments of the invention.

### DETAILED DESCRIPTION OF PREFERRED EMBODIMENTS

As used herein, a credit account is defined as (i) a credit card account where a line of credit is extended, associated with one or more physical credit cards of conventional or unconventional form factor; or (ii) an account that has an account number similar to a credit card account number, which number can be used for authorization requests to access a line of credit, in card-not-present transactions, in a payment processing network, but which is not associated with any physical card.

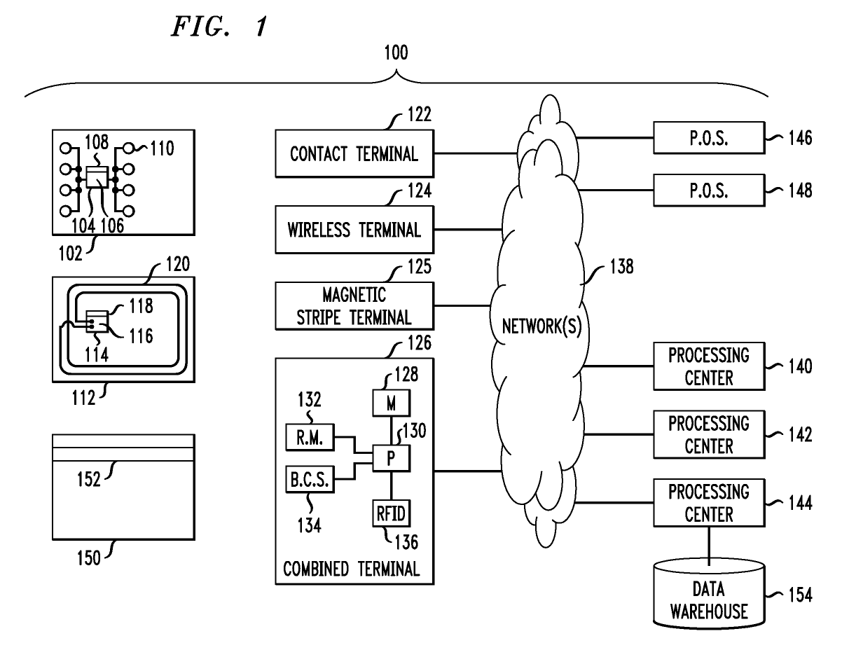

Attention should now be given to FIG. 1, which depicts an exemplary embodiment of a system 100, according to an aspect of the invention, and including various possible components of the system. It should be noted that for completeness and generality, presentation of physical cards to terminals will be described. However, one or more embodiments of the invention are, as noted, to credit accounts regardless of whether they are associated with physical cards. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. Other types of devices used in lieu of or in addition to “smart” or “chip” cards 102, 112 could include a conventional card 150 having a magnetic stripe 152, an appropriately configured cellular telephone handset, and the like. Indeed, techniques can be adapted to a variety of different types of cards, terminals, and other devices, configured, for example, according to a payment system standard (and/or specification).

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions or units 108, 118 can store the operating system of the cards 102, 112. The operating system loads and executes applications and provides file management or other basic card services to the applications. One operating system that can be used is the MULTOS® operating system licensed by MAOSCO Limited (MAOSCO Limited, St. Andrews House, The Links, Kelvin Close, Birchwood, Warrington, WA3 7PB, United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

As noted, cards 102, 112 are examples of a variety of payment devices that can be employed. The primary function of the payment devices may not be payment, for example, they may be cellular phone handsets. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to implement appropriate functionality. The applications can be, for example, application identifiers (AIDs) linked to software code in the form of firmware plus data in a card memory such as an electrically erasable programmable read-only memory (EEPROM). Again, note that “smart” or “chip” cards are not necessarily required and a conventional magnetic stripe card can be employed; furthermore, as noted above, one or more embodiments are of interest wherever credit is extended in a credit account, including accounts having no physical card.

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (for example, a virtual private network, such as the BANKNET® virtual private network (VPN) of MasterCard International Incorporated of Purchase, N.Y., USA). More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 140, 142, 144 can include, for example, a host computer of an issuer of a payment device (or processing functionality of other entities discussed in other figures herein). Issuers can include issuers for cardless credit card accounts as well.

Many different retail or other establishments, as well as other entities, generally represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to implement appropriate functionality. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

Again, conventional magnetic stripe cards 150 can be used instead of or together with “smart” or “chip” cards, and again, cards and other payment devices are described for completeness, as one or more embodiments are of particular interest in the context of card-not-present Internet transactions.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128, which then contactlessly transmits the electronic data to the proximity IC chip in the card 112 or other wireless device. Magnetic stripe cards can be swiped in a well-known manner. In some instances, the card number is simply provided via web site, in a card-not present transaction or the like.

One or more of the processing centers 140, 142, 144 can include a database such as a data warehouse 154; for example, to hold transaction data as described below.

In the context of card-not-present Internet transactions, the card or other device is not presented to terminal 122, 124, 125, or 126. Rather, appropriate account information (e.g., primary account number (PAN), cardholder name, cardholder address, expiration date, and/or security code, and so on) is provided to a merchant by a consumer using a web site or the like. The merchant then uses this information to initiate the authorization process.

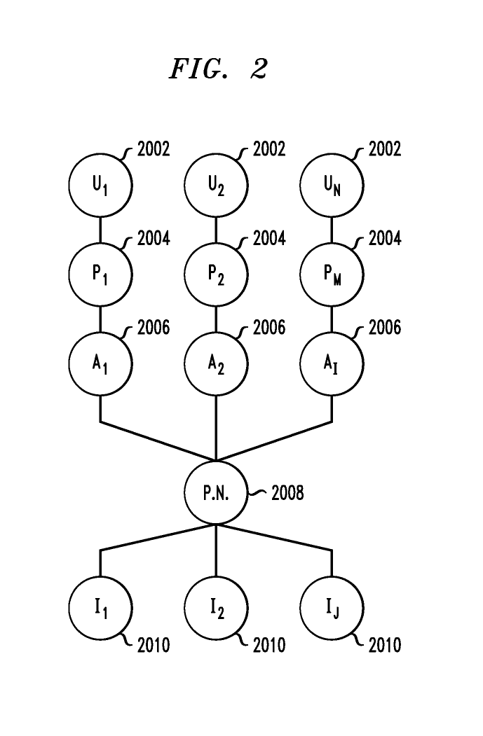

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, 1₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the cardholder 2002 pays for the purchase and the merchant 2004 submits the transaction to the acquirer (acquiring bank) 2006. During Internet commerce, for example, the cardholder may simply provide the card number, expiration date, security code, and/or other pieces of data described above to the merchant, who prepares an authorization request based upon same without actually seeing the physical card. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

It will be appreciated that the network 2008 shown in FIG. 2 is an example of a payment network configured to facilitate transactions between multiple issuers and multiple acquirers, which may be thought of as an “open” system. A wide variety of other types of payment networks can be used. For example, some embodiments of the invention may be employed with proprietary or closed payments networks with only a single issuer and acquirer; one or more embodiments are useful whenever a line of credit is extended.

One or more embodiments of the invention provide a new process for assigning risk to credit card behavior, so that appropriate action can be taken in response to the risk indication—typically, a credit line increase or decrease. In one or more embodiments, the risk is evaluated not just based on the probability that the cardholder is going to default on the loan but also based on the total profitability of the behavior. One or more embodiments rank people based on how much profitability they can bring to the credit card issuer and use that score to make a credit line decision.

Thus, one or more embodiments provide a credit card profitability model, wherein transaction data is used to optimize credit line decrease decisions. One or more embodiments maximize credit card profitability and allow issuers to make optimal credit line decrease decisions.

Heretofore, in a traditional (credit) line management approach, the probability of default is measured, average behavior is assumed for loss prediction, the financial impact is overlaid at segment level based on the probability of default, and the cut-off score and (credit) line decisions are driven by policy simulations.

In one or more embodiments, financial impact is modeled in one equation. Account level profit predictions are employed, and the cut-off score is set at optimal profitability. Credit line decisions are driven by the model.

One or more embodiments do not assume an average behavior for an entire population. One or more instances separate the impact of the initial credit line assignment at acquisition in modeling true changes in the risk profile (high utilization is a key driver of default but has low value in estimating the financial impact). One or more embodiments optimize the use of transaction data (high spend leads to high balance, and high balance has more weight in the profitability calculations). Furthermore, one or more instances permit comparison of measures that have a real impact on the business. One or more exemplary embodiments output a currency (e.g. dollar) amount instead of a ranking.

One or more embodiments employ the following methodology. Customers who default will generate losses, and customers who are current in their payments and who employ their revolving lines of credit will generate interest revenue on their running balances. The modeled profitability in the next 12 months, P, is defined as follows. If the card is charged-off in the next 12 months (cardholder defaults), P is always negative or 0:

P=Min {(Today's Bal−C/O Bal), 0} (1)

In the above equation:
Today's Bal=balance on date prediction is being done
C/O Bal=balance at time of charge-off, that is, the time when it is concluded that the person will not pay and the account must be written off as a bad debt

If the card is not charged-off in the next 12 months, P is always positive or 0, depending on the increment in the balance in the next 12 months:

I=Financing charge paid on the outstanding balances

P=Max {(Avg Bal next 12 mths—Today's Bal)*I, 0} (2)

In one or more embodiments, the model is then:

P=f (payment data, bureau data, transaction data) (3)

This assumes that once a customer is identified as high-risk (e.g. top 5%), the remaining credit line will be reduced.

Thus, in one or more embodiments, what is modeled is the probability of a certain revenue; i.e., a measure of profitability—measure the probability of having a certain profitability. On the loss side, in one or more instances, the profitability is calculated as follows. If the account goes delinquent, then the issuer loses the balance that the cardholder has run from the time of the score, not the entire charge-off balance, but rather only the balance at the time of the evaluation of risk. This is Equation (1) above, on the loss side.

At any time when the risk of an account is determined, and it subsequently “goes bad,” then the only balance that can actually be acted on is up to the credit line at that point—the balance that is left on the credit card, i.e., the open to buy balance from that time on. That is the only thing that can be cut and that is the only thing on the loss side that can be lost, as whatever was used on the credit line prior to that time is already lost.

This aspect is significant in one or more embodiments because many issuers, on the loss side, when calculating at the portfolio level, first calculate the probability that the account goes bad and then apply an average. Issuers may try to determine, at the account level, whether the account will default or not. However, heretofore, when they estimate how much they will lose or make, they apply a portfolio average. In contrast, one or more embodiments of the ‘invention predict the (profit/loss) value at the account level.

One or more embodiments employ the insight that, if the cardholder has a certain balance today and it is charged off, then the balance the cardholder has had up to today is already lost, and cannot be recovered. However, if the issuer takes the right action, the issuer can cut the line to that balance and not lose anything else. Thus, on the loss side, the issuer either loses (i) zero (because the issuer made a good decision) or (ii) the difference between today's balance and the line (when the account defaults and it is necessary to charge off the loan).

By way of review, if, in the next twelve months, the card is charged off, the best that can be hoped for is not to lose anything further. Therefore, the profitability is either negative or zero; one takes the minimum of zero and a negative number in accordance with Equation (1).

On the other hand, suppose the issuer correctly lets the account continue to revolve and the account does not go bad (i.e., a false positive has been avoided). What can be earned is the interest on the future revolving balance. So, if the account does not charge off and the issuer cuts the line, the issuer loses the chance to make more money (the zero in Equation (2)). However, if the issuer perceives the situation correctly and makes the correct decision, then what the issuer earns is the interest on the future revolving balance. Thus, unlike current techniques, one or more embodiments always start from today's balance.

To summarize:
if the account goes delinquent and charges off and the issuer makes the correct decision, the issuer loses nothing (i.e., nothing additional);
if the account goes delinquent and charges off and the issuer makes the wrong decision, the issuer loses the difference between the charge-off balance and today's balance;
if the account does not go delinquent and the issuer makes the correct decision, the issuer earns something; namely, the average balance over the next twelve months less the current balance, times the interest rate;
If the account does not go delinquent and the issuer makes a bad decision, the issuer earns nothing.

Thus, one or more embodiments permit forecasting all of these combinations.

Thus, as per Equation (3), one or more embodiments predict both what is going to happen and what will be lost.

Thus, one or more instances, at the account level, predict not only whether the account will go delinquent, but also what the gain is from the correct prediction. Note that it is possible to go delinquent and yet the gain for the bank from the right prediction is small, because the account is already highly utilized up to its credit line. For example, if the cardholder has already used 95% of his or her credit line and now the bank realizes he or she will likely go delinquent, only 5% of the credit line can be saved. Knowing that such an account will go delinquent is not a very valuable piece of information. What is more valuable to predict is the case that an account with a significant balance (i.e., significant percentage of the credit line) left will go delinquent. One advantage of one or more embodiments is the ability to identify people who still have a large remaining open to buy amount and yet are at risk of default. One or more embodiments advantageously make such an evaluation on an account-by-account basis, rather than in an aggregated fashion.

Furthermore in this regard, and with reference to Equation (3), one or more embodiments find such people who have a lot of credit line left but are likely to default by using primarily transaction data. The purchase data gives an indication of the propensity to default with a certain value left in the account. Purchase data is obtained from the transaction data, in one or more embodiments. Other significant data is repayment data and bureau data—these are all predictors of what it is desired to optimize.

Forecasting a specific amount is challenging and may not be useful in some instances, so one or more embodiments bucket the values of the continuous dependent variables so that they are, in essence, discretized. The distribution of profitability function takes a shape that is illustrated in FIG. 7 below. The function is usually not known and cannot be effectively modeled as a continuous variable. In order for the model to be able to fit this curve with the predictors, one or more embodiments break up the continuous function into profitability buckets.

One or more instances treat the continuous dependent variables as if they were recorded ordinally and employ logistic regressions on each bucket. See discussion of FIG. 7 below.

By way of further explanation, if the function that it is desired to predict is a straight line, then it will be relatively easy to fit with a linear regression. If the function is of a known form, then it is also easy to find a suitable fit. However, the profitability function typically takes a shape that is not well-known; that is, it is not known a priori what functional form it will assume. Thus, one or more embodiments treat it as a series of discrete buckets which have the property of being ordinal.

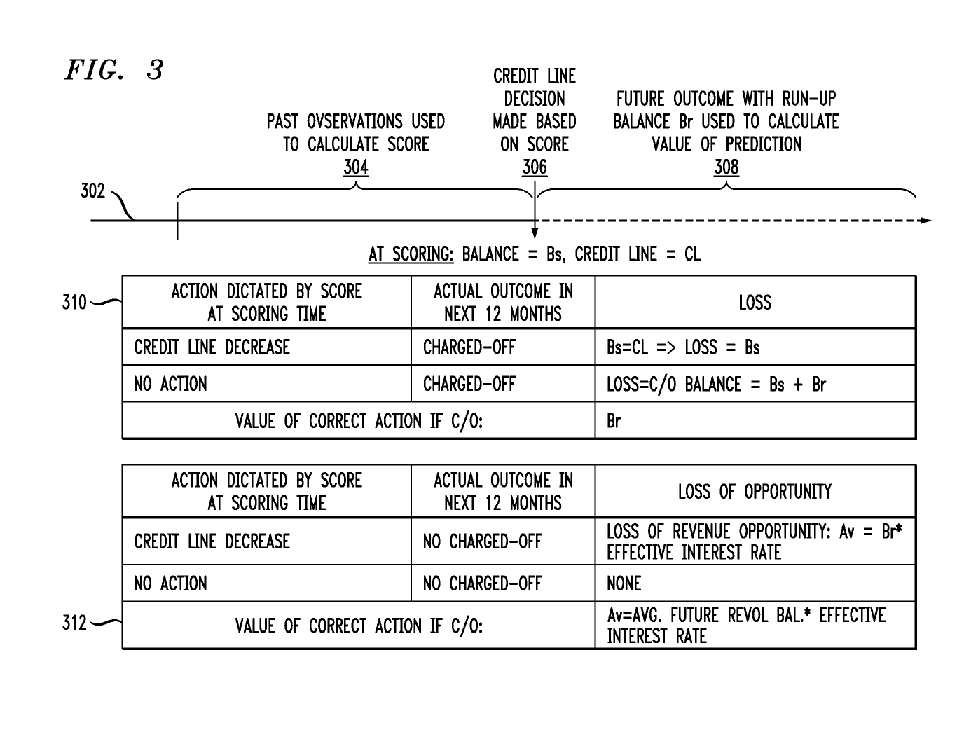

Reference should now be had to FIG. 3, which illustrates the value of correct actions taken by an issuer. Note timeline 302. The past portion 304 of the timeline 302 includes past observations used to calculate the score. Location 306 represents the present time, where the credit line decision is made based on the score. At scoring, the balance is Bₛ and the credit line is CL. What can be saved is the unused portion (see future outcome portion of the line 308), wherein the run-up balance Bᵣ is used to calculate the value of the prediction. If there is no charge off, the issuer gains interest on the revolving balance.

To summarize the parameters:
Bₛ=balance at scoring; today's balance;
Bᵣ=run-up balance; balance from time of scoring—balance in the future—change in balance from time of scoring to time of charge off—the only balance that can be acted on;
Aᵥ=average revolving balance; multiple by interest rate, i, to obtain loss of opportunity (one or more embodiments use the annual percentage rate, APR).

This is why the equation and the target of the equation are significant in one or more embodiments. It is relatively easy to predict who will go delinquent and who will not—this is highly correlated with utilization. However, heretofore, issuing banks have known too late when the balance (i.e., credit line) is already 95% utilized that the account will go bad, inasmuch as, by then it is too late to act in a way that saves a significant amount of money. Current risk models thus do not focus on the appropriate things and one or more embodiments provide a better way to deal with this type of situation.

Still referring to FIG. 3, at 310, note the situation when a charge off occurs in the next twelve months. If the model dictates that the credit line should be decreased, the loss is simply Bₛ, the amount of the credit line already used at the time of the scoring decision. If the model dictates that the credit line should not be changed, the loss is Bₛ, the amount of the credit line already used at the time of the scoring decision, plus Bᵣ, the amount of the run-up balance (amount allowed to be run up between point 306 when the scoring is done and the right end-point of line 302 when the default occurs). On the other hand, at 312, note the situation when a charge off does not occur in the next twelve months. If the model dictates that the credit line should be decreased, there is a loss of opportunity Aᵥ=Bᵣ* effective interest rate (average revolving balance; multiply by interest rate, 1, to obtain loss of opportunity—as noted, one or more embodiments use the annual percentage rate, APR). If the model dictates that the credit line should not be changed, there is no lost opportunity.

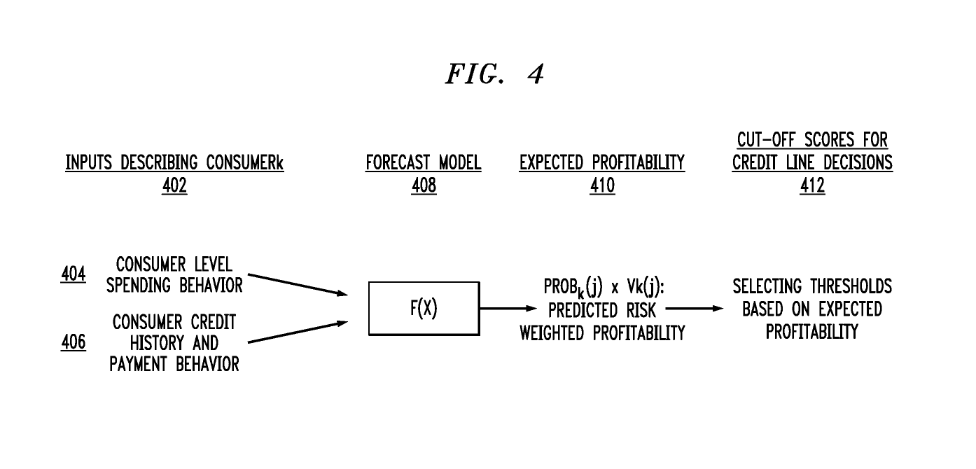

Referring now to FIG. 4, additional details will be provided regarding an exemplary modeling process for credit card profitability scoring. FIG. 4 provides a process overview. As seen at 402, inputs are obtained to describe consumer k. These include consumer-level spending behavior 404 and consumer credit history and payment behavior 406. These are the inputs to forecast model F(x) at 408. The output of the model, expected profitability 410, includes the predicted risk-weighted profitability Probₖ(j)×Vₖ(j). Cut-off scores for credit line decisions are made at 412, selecting thresholds based on expected profitability.

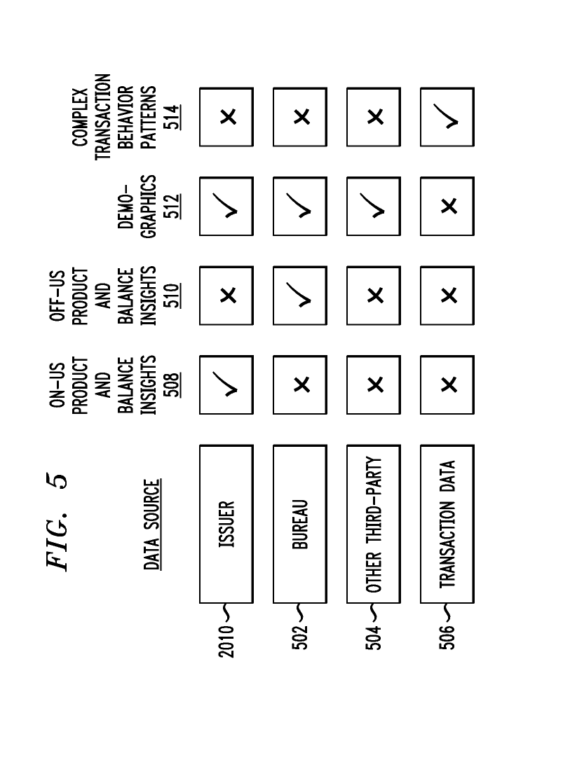

Further details regarding the model inputs are given with respect to FIG. 5. The transaction data complements other available data sources. It is typically standardized and is more reliable than self-reported data. In one or more embodiments, purchase transaction behavior data has rich information embedded therein which is not available elsewhere. Data sources include the issuer 2010, bureau 502, other third party(ies) 504, and transaction data 506. Possible information to be gleaned from the various data sources includes insights on products and information on balances held with the issuer 508, insights on products and information on balances held with other issuers 510, demographics 512, and complex transaction behavior patterns 514. As seen in FIG. 5, issuer data affords information 508, 512 but not 510, 514; bureau data affords information 510, 512 but not 508, 514; other third-party(ies) data affords only demographic data 512; and transaction data 506, while not providing information 508, 510, 512, advantageously provides information 514 on the aforementioned complex transaction behavior patterns.

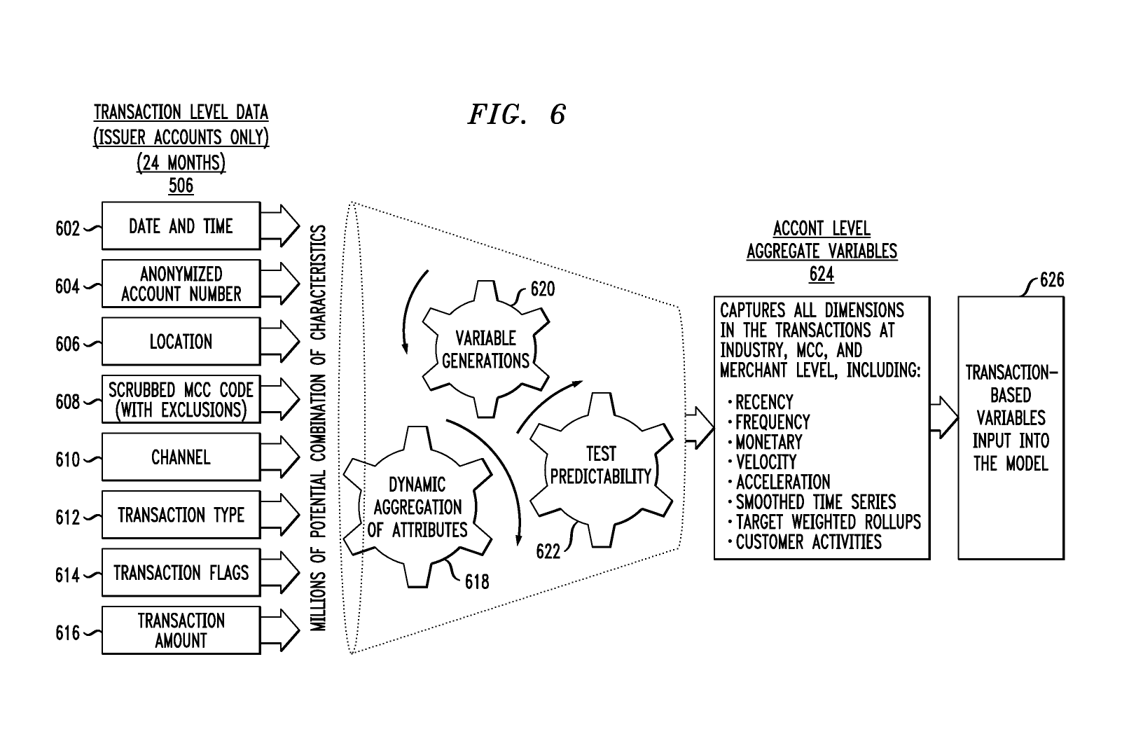

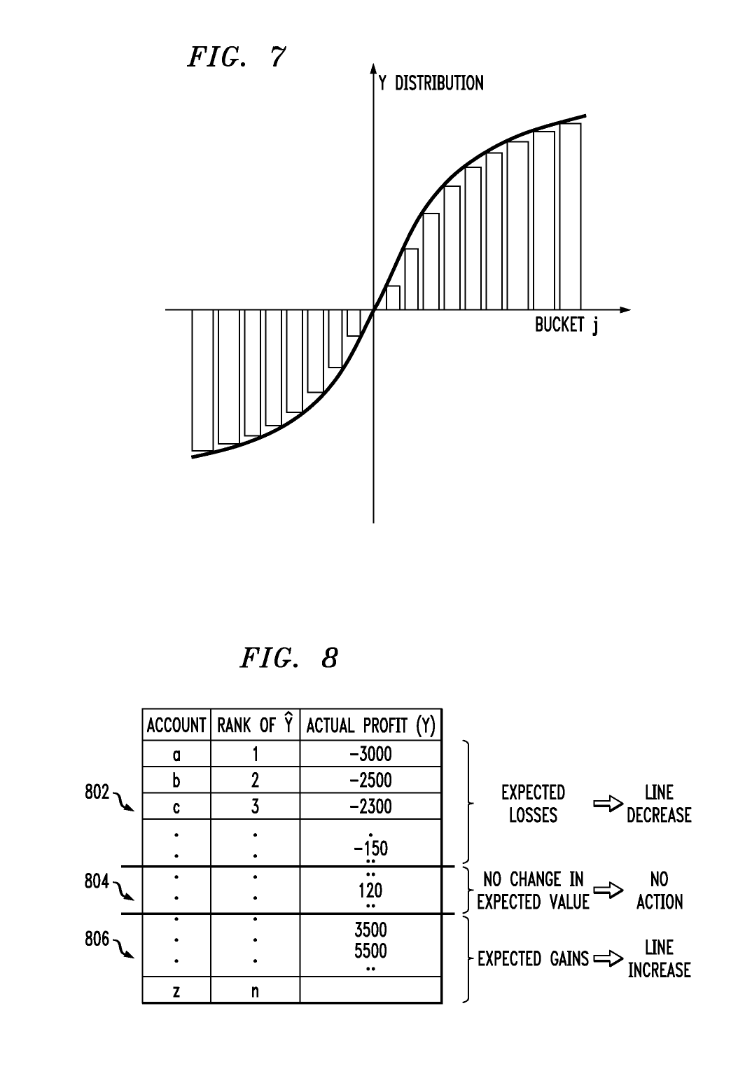

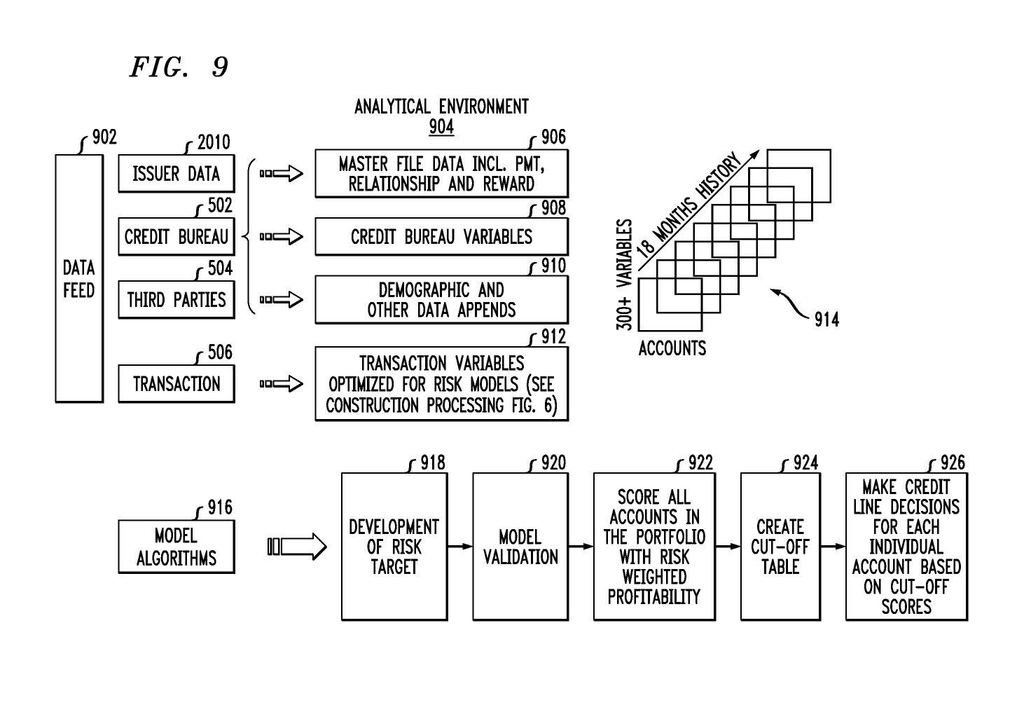

FIG. 6 depicts exemplary construction of customer level transaction input variables. Transaction level data 506 may be gathered for some suitable period of time (by way of example and not limitation, 24 months). In some instances, transaction data from processing systems is loaded into a data warehouse system to collect, transform and summarize the data. Examples of such data include:
date and time 602;
anonymized account number 604 (anonymous id representing the credit card number but not personally traceable to the card holder);
location 606;
Cleansed merchant category code (MCC) 608 with any exclusions (the skilled artisan will of course appreciate that an MCC is a four-digit number assigned to a business by the operator of a payment network such as MasterCard International Incorporated or VISA Inc. when the business first starts accepting one of these cards as a form of payment; the MCC is used to classify the business by the type of goods or services it provides; and a “cleansed” MCC refers to correcting any errors in the MCC for example by checking the received MCC against other data received and possibly changing the MCC if it is not consistent with other data received);
channel 610;
transaction type 612;
transaction flags 614; and/or
transaction amount 616.

There are millions of potential combinations of characteristics.

As seen at 618, 620, 622, the transaction level data is subjected to dynamic aggregation of attributes and variable generation, and predictability is tested. This leads to the account level aggregate variables 624, which, in one or more embodiments, capture most dimensions in the transactions at industry, MCC, and merchant levels, including, for example, recency (i.e. time since last transaction), frequency, monetary, velocity, acceleration, smoothed time series, target weighted roll-ups, and/or customer activities. At 626, these transaction-based variables are input into the model. Dimensions include recency, velocity at which the spending occurs, the timing (e.g., weekend versus weekday spending), and the ratio over the total spend (e.g., percentage spend in retail versus total spending).

Exemplary aspects of construction of the dependent variable will now be presented. The target variable Y is defined as follows:
a. If the card is charged-off in the next 12 months, Y is always negative or 0. In general, higher in utilization, lower in losses.

Y=Min {Outstanding Balance at time of scoring−Charge_off_Balance, 0}
b. If the card isnot charged-off in the next 12 months, Y is always positive or 0, depending on the increment in balance in the next 12 months.

Y=Max {(Avg. Balance 12 months after scoring time−Outstanding Balance at time of scoring)*I, 0)

In one or more embodiments, Y is then discretized into buckets of profitability levels, as seen in FIG. 7.

Exemplary modeling methodology will now be considered. One or more embodiments treat the continuous dependent variable (DV) as if it was recorded ordinally. Since DV was divided into j categories, the model used is:

$$\begin{matrix}{c}_{k} ( x ) = ln \frac{P ( Y \leq j \vert x )}{P ( Y > j \vert x )} \\ = ln \frac{{f}_{0} ( X ) + {f}_{1} ( X ) + … {f}_{j} ( X )}{{f}_{j + 1} ( X ) + {f}_{j + 2} ( x ) + … {f}_{j} ( x )} \\ = {α}_{j} - {χ}^{′} β\end{matrix} \qquad ( 4 )$$

### Where:

αⱼ are the cut-off points between the categories, and

fᵢ(x) is the probability of being in class i given covariates x.

One or more embodiments employ the proportional odds assumption. The proportional odds assumption is then that the βs are independent of j. If the proportional odds assumption is not met, there are several options:
1. Collapse two or more levels, particularly if some of the levels have small N;
2. Perform bivariate ordinal logistic analyses, to see if there is one particular independent variable (IV) that is operating differently at different levels of the dependent variable (DV);
3. Use a partial proportional odds model;
4. Use multinomial logistic regression.

Exemplary aspects of checking model fit will now be discussed. In one or more embodiments, assessment of fit, residuals, and influential points can be done by the usual methods for binomial logistic regression, performed on each of j-1 regressions. In one or more embodiments, a technique is employed wherein logistic regressions predict whether the subject belongs in one or the buckets; 0 indicates belonging and 1 indicates not belonging (the opposite symbolism could of course also be employed). This is compared to the next bucket; again, 0 indicates belonging and 1 indicates not belonging (again, the opposite symbolism could of course also be employed). Depending on how many buckets or slices, there will be the corresponding number of logistic regressions. To validate that the model has a good fit, each of the regressions can be validated based on the fit of the logistic curve. In one or more embodiments, there are j slices and j-1 regressions.

Note that, give the teachings herein, the skilled artisan will be able to select suitable regression techniques to implement one or more embodiments of the invention. Reference is made to Peter L. Flom, Multinomial and ordinal logistic regression using PROC LOGISTIC, 18th annual NESUG (NorthEast SAS Users Group) Conference, Sep. 11-14, 2005, Portland, Me., USA, which is hereby expressly incorporated by reference herein in its entirety for all purposes. PROC LOGISTIC within the well-known SAS statistical software can be used to combine the logistic regressions and to validate the individual regressions.

Now consider the model outputs. One or more embodiments use the βs coefficients to calculate cumulative predicted probabilities from the logistic model for each case (the double asterisk ** indicates exponentiation):

Prob(class≦j)=1/(1+e**(−(αⱼ−βⱼ))) (5)

From the estimated cumulative probabilities, the estimated probabilities of the individual scores can be readily calculated by subtraction, using the formula:

Pⱼ−Prob(class=j)=Prob(class≦j)−Prob(class<j) (6)

In one or more embodiments, assign a ranking score to each account based on the expected value of the profitability:

ŶΣPⱼVⱼ, with Vⱼ=mean interval of bucket j. (7)

From the development data, the cut-off decision table of FIG. 8 can be constructed. The three columns are the accounts a, b . . . z; the ranking score of Equation (7); and the actual profit (Y). Region 802 represents cases where losses are expected and the credit line should be decreased; region 804 represents cases where the is no change in expected value and no action is taken; and region 806 represents cases where there are expected gains and the credit line is increased.

Exemplary delivery of a modeling service will now be described in the context of the exemplary architecture diagram of FIG. 9. Once a line of credit is extended to a customer by a bank, the bank actively monitors the creditworthiness of the customer. In order to improve profitability, credit-line decisions should be based on a model that captures changes in a customer's risk profile in a timely manner, and at the same time optimizes the actionability on the account for maximum profitability. As seen at data feed block 902, the data sources 2010, 502, 504, 506, discussed above with respect to FIG. 5, each provide data to a corresponding part of the analytical environment 904. In particular, as seen at 906, issuer data 2010 includes master file data including payment, relationship, and reward; as seen at 908, credit bureau data 502 includes credit bureau variables; as seen at 910, third party(ies) data 504 includes demographic and other data appends; and, as seen at 912, transaction data 506 includes transaction variables optimized for risk models (see construction process described with respect to FIG. 6).

As seen at 914, a plurality of accounts are analyzed for a predetermined time period (here, by way of example and not limitation, 18 months), and a large number of variables (here, by way of example and not limitation, more than three hundred) are taken into account. The model algorithms 916 are employed in the development of risk targets, as seen at 918, and model validation is carried out at 920. At 922, all the accounts in the portfolio are scored with risk-weighted profitability, and at 924, a cut-off table is created. At 926, credit line decisions are made for each individual account based on the cut-off scores.

Issuer data from issuer 2010 can be obtained from a bank's processing system, such as an issuer platform. Credit bureau data from credit bureau 502 and other third party data from third party(ies) 504 can be fed, for example, quarterly or monthly from the credit bureau or other third party's separate database into a suitable database associated with the analytical environment 904. Transaction data 506 can be provided from a network such as the BANKNET network, VISANET network, or similar single-issuer or multiple-issuer payment processing network.

### Experimental Results

Experiments were conducted on anonymized data to determine the performance of a non-limiting exemplary embodiment. It has been observed that in one or more instances, the methodology results in significant incremental financial impact and can accommodate additional factors provided by for an optimization of the final economic loss. Note that current charge off probability models are typically utilization driven models, which combine high and low balance charge-offs together and cause bias in value calculation. In the profit model approach in accordance with one or more embodiments of the invention, the significance of utilization is reduced and the transaction data become more significant in the model.

### Recapitulation

Given the discussion thus far, it will be appreciated that, in general terms, an exemplary method, according to an aspect of the invention, includes the step of obtaining data (e.g., 502, 504, 506) for a plurality of credit accounts for a first predetermined period of time. In general, the accounts can be cardless accounts, accounts associated with conventional cards and/or accounts associated with unconventional form factor cards. Furthermore, the data can be obtained from an entity that collects it or can be collected directly. Yet further, the data can be obtained in a raw form and processed, or can be obtained in a processed form. In a non-limiting example, the data is raw transaction-level data and is aggregated into account-level data as described elsewhere herein. The obtaining step can be carried out, for example, using a suitable database program to read a file from a database.

A further step includes, for each account in the plurality of credit accounts, calculating an expected profitability based on the data. The expected profitability includes, for each given one of the accounts, an estimated probability of default (Probₖ(j)) for a given one of the accounts multiplied by, for each given one of the accounts:
the minimum of zero and an increase in balance from scoring to default, in case of a default within a second predetermined period of time (Equation 1); and
the maximum of zero and the increase in balance from scoring to default, multiplied by an annual percentage rate, in case of no default within the second predetermined period of time (Equation 2).

A further step includes taking at least one action based on the expected profitability calculated for the plurality of credit accounts. In this regard, one or more embodiments are analogous to a medical diagnostic tool. The issuer, analogous to the doctor, decides what to do based on the output of the tool. Non-limiting examples include increasing or reducing credit lines; the action taken is up to the issuer, which takes action deemed appropriate based on the calculated expected profitability.

In some cases, the at least one action includes selecting at least a first cut-off score which divides a first group 802 of the accounts which are to have a reduction in their credit lines, based on the calculated expected profitabilities, from a second group of accounts 804 which are to have no change in their credit lines, based on the calculated expected profitabilities. Cut-off scores may be selected, for example, at least I part based on human judgment.

In some instances, a further step includes reducing the credit lines of the first group of accounts.

Some embodiments further include selecting at least a second cut-off score which divides the second group of accounts 804 which are to have no change in their credit lines, based on the calculated expected profitabilities, from a third group of accounts 806 which are to have an increase in their credit lines, based on the calculated expected profitabilities.

In some instances, a further step includes increasing the credit lines of the third group of accounts.

The foregoing are non-limiting specific examples. In general, the at least one action can include, for example, reducing a credit line of at least one of the plurality of credit accounts; increasing a credit line of at least one of the plurality of credit accounts; and/or marketing at least one of a product and a service (for example, offering a balance transfer if the cardholder has a favorable expected profitability) to a cardholder associated with at least one of the plurality of credit accounts. In some instances, if a card holder has a low chance of going delinquent, he or she is given a bonus.

In a preferred but non-limiting approach, as shown, for example, in FIG. 6, the obtaining step includes obtaining transaction-level data 506 associated with individual transactions carried out with the plurality of credit accounts; and aggregating the transaction-level data into account-level data 624 associated with given individual credit accounts of the plurality of credit accounts.

Referring still to FIG. 6 and also to FIG. 9, one or more embodiments compile information from different sources into one location, such as one database. Information comes in from different sources. Raw transaction data is cleansed and account-level aggregate variables are determined. Internal data from the processor (bank) 2010 plus credit bureau data 502 and other third party data 504 is employed.

Thus, one or more embodiments carry out aggregation including changing transaction level data to account level data, creating new variables, cleaning the data, and aggregating the merchants into merchant categories. These processes can be carried out, for example, using commercial software and databases. There is also some manual work. Examples of suitable software include the IBM NETEZZA® data warehouse appliance (registered mark of IBM INTERNATIONAL GROUP BV LIMITED LIABILITY COMPANY, AMSTERDAM NETHERLANDS), SAS® software (registered mark of SAS Institute Inc., SAS Campus Drive, Cary, N.C. 27513, USA), and the SQL (Structured Query Language) programming language designed for managing data in relational database management systems (RDBMS).

Thus, in one or more embodiments, aggregation involves taking transaction level elements, such as time, amount, location, merchant and/or MCC; and aggregating them at the account level to create variables at the account level that capture appropriate information, effectively matching same to an account instead of a transaction. Data is sued to characterize the purchase behavior of that account holder. With a number of data points for the account holder, predictions can be made. Other sources of information are not as good in predicting the actual value at risk. Other sources are driven by utilization of the credit line as a predictor, but once the line is highly utilized, it is typically too late to save anything. Efficient implementation of techniques depicted in FIG. 3 is facilitated by transaction level detail mapped to the account level. One or more embodiments take into account utilization of the credit line as to the amount that can be saved but do not necessarily use this as a predictor per se.

As described above in connection with Equations 4-7 and FIG. 7, one or more embodiments determine the estimated probability of default for each of the accounts based on a discretization of the account-level data.

Some embodiments include the further step of providing a system. The system in turn comprises distinct software modules, each embodied, in a non-transitory manner, on at least one tangible computer readable recordable storage medium. The distinct software modules include a database module, an input/output module, a probability estimation engine module, and a score ranking module. The data obtaining step is carried out by the database module executing on at least one hardware processor. The calculation of the expected profitability includes calculating estimated probabilities of individual scores with the probability estimation engine module executing on the at least one hardware processor (e.g., module programmed to implement logic of equation (6)); and assigning a ranking score to each account in the plurality of credit accounts with the score ranking module executing on the at least one hardware processor (e.g., module programmed to implement logic of equation (7)). Further, the taking of the at least one action includes at least forwarding the expected profitability with the input/output module executing on the at least one hardware processor.

### System and Article of Manufacture Details

Embodiments of the invention can employ hardware and/or hardware and software aspects. Software includes but is not limited to firmware, resident software, microcode, etc. Software might be employed, for example, in connection with one or more of a terminal 122, 124, 125, 126; a reader 132; payment devices such as cards 102, 112; a host, server, and/or processing center 140, 142, 144 (optionally with data warehouse 154) of a merchant, issuer, acquirer, processor, or operator of a network 2008 operating according to a payment system standard (and/or specification), as well as any of the blocks in FIG. 9. Firmware might be employed, for example, in connection with payment devices such as cards 102, 112 and reader 132. Firmware provides a number of basic functions (e.g., display, print, accept keystrokes) that in themselves do not provide the final end-use application, but rather are building blocks; software links the building blocks together to deliver a usable solution.

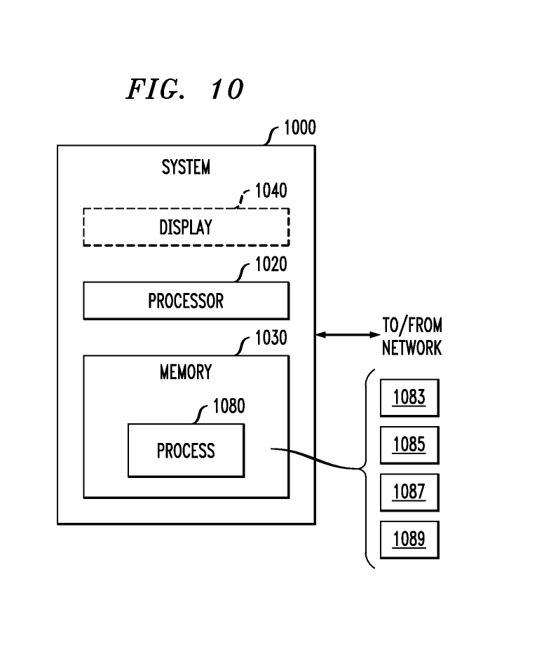

FIG. 10 is a block diagram of a system 1000 that can implement part or all of one or more aspects or processes of the invention. As shown in FIG. 10, memory 1030 configures the processor 1020 (which could correspond, e.g., to processor portions 106, 116, 130; processors of remote hosts in centers 140, 142, 144; processors of servers implementing the blocks of FIG. 9, and the like) to implement one or more aspects of the methods, steps, and functions disclosed herein (collectively, shown as process 1080 in FIG. 10). Different method steps can be performed by different processors. The memory 1030 could be distributed or local and the processor 1020 could be distributed or singular. The memory 1030 could be implemented as an electrical, magnetic or optical memory, or any combination of these or other types of storage devices (including memory portions as described above with respect to cards 102, 112). It should be noted that if distributed processors are employed, each distributed processor that makes up processor 1020 generally contains its own addressable memory space. It should also be noted that some or all of computer system 1000 can be incorporated into an application-specific or general-use integrated circuit. For example, one or more method steps could be implemented in hardware in an ASIC rather than using firmware. Display 1040 is representative of a variety of possible input/output devices (e.g., displays, mice, keyboards, and the like).

The notation “to/from network” is indicative of a variety of possible network interface devices.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is intended to encompass a non-transitory recordable medium, examples of which are set forth above, but is not intended to encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on elements 140, 142, 144, 2010, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, 140, 142, 144, blocks of FIG. 9, 2004, 2006, 2008, 2010 can make use of computer technology with appropriate instructions to implement method steps described herein. The various platforms, can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 1000 as shown in FIG. 10) running a server program. It will be understood that such a physical server may or may not include a display, keyboard, or other input/output components. A “host” includes a physical data processing system (for example, system 1000 as shown in FIG. 10) running an appropriate program. It will be understood that such a host may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. In some cases, the modules include a database module 1083, an input/output module 1085, a probability estimation engine module 1087, and a score ranking module 1089. Each module represents instructions stored in a non-transitory manner in a non-volatile portion of memory 1030 which when executed cause processor 1020 to implement the described logic. Modules that can be provided include, for example, a discretization module, a logistic regression module, a validation and testing module, a rank ordering module, and the like. In a more detailed, non-limiting example, the modules include:
Treatment module which performs discretatization of the profitability function
Preliminary analysis module which applies necessary and appropriate exclusions to the data to ensure that the population on which the model is being developed is representative of the population on which the model will be deployed. Initial analysis will also typically include evaluating the impact of each data element available for analysis on the behavior desired
Model Development module: employs logistic regression analysis technique to determine the significant variables and their weights, which have an impact on customer propensity to exhibit the desired behavior. The variables descriptions, their relative weights, and the directionality of impact of each on the propensity are analyzed
Model Performance Analysis module: divides the population into deciles (or the like) based on predicted score values and compares “actual” behavior across deciles to assess if groups with higher “predicted” scores demonstrate higher levels of the “actual” effect—i.e., if there is rank-ordering, as well as comparing the impact of targeting deciles based on “predicted scores” vs. “no model” in capturing “actual” effect within the targeted decile (model lift).
Model Validation module: evaluates the model developed on the development sample on the validation sample for stability of model parameters and performance. Subject to availability of data, the model is “retro-scored” on an additional validation sample from a different time-period and evaluated for stability and performance.
Score file delivery module: an input/output module that provides the score file to the appropriate entity—can be as simple as an output routine that prepares a comma separated value or similar file or as elaborate as a graphical user interface (GUI)

The blocks may be implemented by the software modules together with corresponding memories and one or more processors. The modules can run, for example on one or more hardware processors of one or more servers 1000; in general, all could run on the same server, each could run on a separate server, and so on. In a preferred but non-limiting approach, the modules run on one or more servers of an issuer 2010; for example, at a processing center 140, 142, 144 thereof, in communication with transaction (and/or other) data stored in data warehouse 154. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Computers discussed herein can be interconnected, for example, by one or more of network 138, 2008, another virtual private network (VPN), the Internet, a local area and/or wide area network (LAN and/or WAN), via an EDI layer, and so on. The computers can be programmed, for example; in compiled, interpreted, object-oriented, assembly, and/or machine languages, for example, one or more of C, C++, Java, Visual Basic, JavaScript or other ECMAScript based scripting languages, and the like (an exemplary and non-limiting list), and can also make use of, for example, Extensible Markup Language (XML), JSON, name/value pairs, known application programs such as relational database applications (e.g., SAP software), spreadsheets, and the like. The computers can be programmed to implement the logic depicted in the flow charts and other figures. At least some messages in network 2008, in at least some instances, can be in accordance with ISO 8583.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
obtaining data for a plurality of credit accounts for a first predetermined period of time;
for each account in said plurality of credit accounts, calculating an expected profitability based on said data, said expected profitability comprising, for each given one of said accounts, an estimated probability of default for a given one of said accounts multiplied by, for each given one of said accounts:
the minimum of zero and an increase in balance from scoring to default, in case of a default within a second predetermined period of time; and
the maximum of zero and said increase in balance from scoring to default, multiplied by an annual percentage rate, in case of no default within said second predetermined period of time; and
taking at least one action based on said expected profitability calculated for said plurality of credit accounts.

2. The method of claim 1, wherein said at least one action comprises selecting at least a first cut-off score which divides a first group of said accounts which are to have a reduction in their credit lines, based on said calculated expected profitabilities, from a second group of accounts which are to have no change in their credit lines, based on said calculated expected profitabilities.

3. The method of claim 2, further comprising reducing said credit lines of said first group of accounts.

4. The method of claim 3, further comprising selecting at least a second cut-off score which divides said second group of accounts which are to have no change in their credit lines, based on said calculated expected profitabilities, from a third group of accounts which are to have an increase in their credit lines, based on said calculated expected profitabilities.

5. The method of claim 4, further comprising increasing said credit lines of said third group of accounts.

6. The method of claim 1, wherein said at least one action comprises reducing a credit line of at least one of said plurality of credit accounts.

7. The method of claim 1, wherein said at least one action comprises increasing a credit line of at least one of said plurality of credit accounts.

8. The method of claim 1, wherein said at least one action comprises marketing at least one of a product and a service to a cardholder associated with at least one of said plurality of credit accounts.

9. The method of claim 8, wherein said marketing comprises offering a balance transfer and said cardholder has a favorable expected profitability.

10. The method of claim 1, wherein said obtaining step comprises:
obtaining transaction-level data associated with individual transactions carried out with said plurality of credit accounts; and
aggregating said transaction-level data into account-level data associated with given individual credit accounts of said plurality of credit accounts.

11. The method of claim 10, further comprising determining said estimated probability of default for each of said accounts based on a discretization of said account-level data.

12. The method of claim 1, further comprising providing a system, wherein said system comprises distinct software modules, each of said distinct software modules being embodied, in a non-transitory manner, on at least one tangible computer readable recordable storage medium, and Wherein said distinct software modules comprise a database module, an input/output module, a probability estimation engine module, and a score ranking module;
wherein:
said data obtaining step is carried out by said database module executing on at least one hardware processor;
said calculating of said expected profitability comprises:
calculating estimated probabilities of individual scores with said probability estimation engine module executing on said at least one hardware processor; and
assigning a ranking score to each account in said plurality of credit accounts with said score ranking module executing on said at least one hardware processor; and
said taking of said at least one action comprises forwarding said expected profitability with said input/output module executing on said at least one hardware processor.

13. A system comprising:
a memory;
at least one processor operatively coupled to said memory; and
a persistent storage device operatively coupled to said memory and storing in a non-transitory manner instructions which when loaded into said memory cause said at least one processor to be operative to:
obtain data for a plurality of credit accounts for a first predetermined period of time;
for each account in said plurality of credit accounts, calculate an expected profitability based on said data, said expected profitability comprising, for each given one of said accounts, an estimated probability of default for a given one of said accounts multiplied by, for each given one of said accounts:
the minimum of zero and an increase in balance from scoring to default, in case of a default within a second predetermined period of time; and
the maximum of zero and said increase in balance from scoring to default, multiplied by an annual percentage rate, in case of no default within said second predetermined period of time; and
take at least one action based on said expected profitability calculated for said plurality of credit accounts.

14. The system of claim 13, wherein said at least one action comprises obtaining a selection of at least a first cut-off score which divides a first group of said accounts which are to have a reduction in their credit lines, based on said calculated expected profitabilities, from a second group of accounts which are to have no change in their credit lines, based on said calculated expected profitabilities.

15. The system of claim 14, wherein said persistent storage device further stores in a non-transitory manner instructions which when loaded into said memory cause said at least one processor to be operative to reduce said credit lines of said first group of accounts.

16. The system of claim 15, wherein said persistent storage device further stores in a non-transitory manner instructions which when loaded into said memory cause said at least one processor to be operative to obtain a selection of at least a second cut-off score which divides said second group of accounts which are to have no change in their credit lines, based on said calculated expected profitabilities, from a third group of accounts which are to have an increase in their credit lines, based on said calculated expected profitabilities.

17. The system of claim 16, wherein said persistent storage device further stores in a non-transitory manner instructions which when loaded into said memory cause said at least one processor to be operative to increase said credit lines of said third group of accounts.

18. The system of claim 13, wherein said at least one action comprises reducing a credit line of at least one of said plurality of credit accounts.

19. The system of claim 13, wherein said at least one action comprises increasing a credit line of at least one of said plurality of credit accounts.

20. The system of claim 13, wherein said at least one action comprises marketing at least one of a product and a service to a cardholder associated with at least one of said plurality of credit accounts.

21. The system of claim 20, wherein said marketing comprises offering a balance transfer and said cardholder has a favorable expected profitability.

22. The system of claim 13, wherein said instructions which when loaded into said memory cause said at least one processor to be operative to obtain said data comprises:
instructions which when loaded into said memory cause said at least one processor to be operative to obtain transaction-level data associated with individual transactions carried out with said plurality of credit accounts; and
instructions which when loaded into said memory cause said at least one processor to be operative to aggregate said transaction-level data into account-level data associated with given individual credit accounts of said plurality of credit accounts.

23. The system of claim 22, wherein said persistent storage device further stores in a non-transitory manner instructions which when loaded into said memory cause said at least one processor to be operative to determine said estimated probability of default for each of said accounts based on a discretization of said account-level data.

24. The system of claim 13, wherein said instructions on said persistent storage device comprise distinct software modules, and wherein said distinct software modules comprise a database module, an input/output module, a probability estimation engine module, and a score ranking module;
wherein:
said database module comprises said instructions which cause said at least one processor to obtain said data for said plurality of credit accounts;
said probability estimation engine module and said score ranking module comprise said instructions which cause said at least one processor to calculate said expected profitability, by:
calculating estimated probabilities of individual scores with said probability estimation engine module executing on said at least one processor; and
assigning a ranking score to each account in said plurality of credit accounts with said score ranking module executing on said at least one processor; and
said taking of said at least one action comprises forwarding said expected profitability with said input/output module executing on said at least one processor.

25. An apparatus comprising:
means for obtaining data for a plurality of credit accounts for a first predetermined period of time;
means for, for each account in said plurality of credit accounts, calculating an expected profitability based on said data, said expected profitability comprising, for each given one of said accounts, an estimated probability of default for a given one of said accounts multiplied by, for each given one of said accounts:
the minimum of zero and an increase in balance from scoring to default, in case of a default within a second predetermined period of time; and
the maximum of zero and said increase in balance from scoring to default, multiplied by an annual percentage rate, in case of no default within said second predetermined period of time; and
means for taking at least one action based on said expected profitability calculated for said plurality of credit accounts.

26. The apparatus of claim 25, wherein said means for obtaining comprise:
means for obtaining transaction-level data associated with individual transactions carried out with said plurality of credit accounts; and
means for aggregating said transaction-level data into account-level data associated with given individual credit accounts of said plurality of credit accounts;
further comprising means for determining said estimated probability of default for each of said accounts based on a discretization of said account-level data.

27. An article of manufacture comprising a computer program product, said computer program product comprising:
a tangible computer-readable recordable storage medium, storing in a non-transitory manner computer readable program code, the computer readable program code comprising:
computer readable program code configured to obtain data for a plurality of credit accounts for a first predetermined period of time;
computer readable program code configured to, for each account in said plurality of credit accounts, calculate an expected profitability based on said data, said expected profitability comprising, for each given one of said accounts, an estimated probability of default for a given one of said accounts multiplied by, for each given one of said accounts:
the minimum of zero and an increase in balance from scoring to default, in case of a default within a second predetermined period of time; and
the maximum of zero and said increase in balance from scoring to default, multiplied by an annual percentage rate, in case of no default within said second predetermined period of time; and
computer readable program code configured to take at least one action based on said expected profitability calculated for said plurality of credit accounts.

28. The article of manufacture of claim 27, wherein said computer readable program code configured to obtain said data comprises:
computer readable program code configured to obtain transaction-level data associated with individual transactions carried out with said plurality of credit accounts; and
computer readable program code configured to aggregate said transaction-level data into account-level data associated with given individual credit accounts of said plurality of credit accounts;
further comprising computer readable program code configured to determine said estimated probability of default for each of said accounts based on a discretization of said account-level data.
